(19) United States
(12) Patent Application Publication
(10) Pub. No.: US 2006/0122753 A1
(43) Pub. Date: Jun. 8, 2006

(54) Safety devices for car windows

(76) Inventor: Marina O'Brien, Colonia, NJ (US)

Correspondence Address: Mr. Walter J. Tencza Jr., Suite 3, 10 Station Place, Metuchen, NJ, 08840, US

(21) Appl. No.: 11/004,345

(22) Filed: Dec. 3, 2004

(51) Int. Cl. E05F 15/00

(52) U.S. Cl. 701/49

(57) ABSTRACT

A plurality of actuators, buttons, or switches is located on a driver's door of a vehicle. The plurality of actuators may be grouped together on a panel of the driver's door of the vehicle. Each of the plurality of actuators, buttons, or switches, can enable or disable a particular window device, such as a particular power window device, corresponding to a particular power window of the vehicle. A driver actuator, a front passenger actuator, a left rear actuator, and a right rear actuator can cause a driver window device, a front passenger window device, a left rear window device, and a right rear window device, respectively, to be enabled or disabled.

### FIELD OF THE INVENTION

This invention relates to improved methods and apparatus concerning safety locks for car windows.

### BACKGROUND OF THE INVENTION

In the prior art a single actuator, button, or switch, was provided on a driver's door of a vehicle for disabling all of the vehicle's power windows so that none of the vehicle's power windows could be operated, the purpose typically being the prevention of children from opening the power windows. The single actuator desirably prevents children, such as children in the back seats of a vehicle, from opening the power windows in the vehicle. However, the single actuator also undesirably prevents anyone else, such as an adult sitting in the front passenger seat, from operating any of the power windows in the vehicle, such as the front passenger seat power window.

### SUMMARY OF THE INVENTION

The present invention in one or more embodiments provides a plurality of actuators, buttons, or switches located on a drivers door of a vehicle. The plurality of actuators may be grouped together on a panel of the driver's door of the vehicle. Each of the plurality of actuators, buttons, or switches, can enable or disable a particular window device, such as a power window device, corresponding to a particular power window of the vehicle. In at least one embodiment, a driver actuator, a front passenger actuator, a left rear actuator, and a right rear actuator are provided. The driver actuator, the front passenger actuator, the left rear actuator, and the right rear actuator, can cause a driver window device, a front passenger window device, a left rear window device, and a right rear window device, respectively, to be separately enabled or disabled.

The driver window device, the front passenger window device, the left rear window device, and the right rear window device may be placed and fixed to a driver's door, a front passenger door, a left rear door, and a right rear door.

The present invention, in one or more embodiments, may provide four actuators on the driver's door to enable or disable the opening/closing of power windows for passenger windows. This allows adult passengers to management of the power windows (opening or closing) as desired or needed. For example, an adult passenger may need fresh air or may need to communicate with someone through an open window to, such as for getting directions.

### BRIEF DESCRIPTION OF THE DRAWINGS

FIG. 1A shows a driver's side view of a vehicle for use with an embodiment of the present invention;

FIG. 1B shows a front passenger's side view of the vehicle of FIG. 1A;

FIG. 2 shows a top view of an driver's door panel located on the inside of the vehicle of FIG. 1A; and

FIG. 3 shows a block diagram of a plurality of actuators for disabling a corresponding plurality of window devices.

### DETAILED DESCRIPTION OF THE DRAWINGS

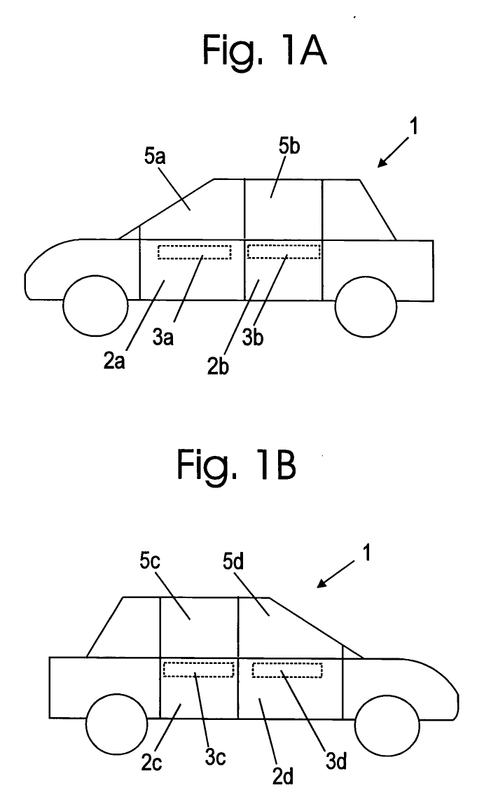

FIG. 1A shows a driver's side view of a vehicle 1 for use with an embodiment of the present invention. The vehicle 1 may be an automobile. FIG. 1B shows a front passenger's side view of the vehicle 1 of FIG. 1A. The vehicle 1 includes a driver's door 2a, a left rear door 2b, a right rear door 2c, and a front passenger door 2d. Dashed lines show the approximate locations of panels 3a, 3b, 3c, and 3d fixed inside the doors 2a, 2b, 2c, and 2d, respectively. Although shown on the outside of the vehicle 1 in FIGS. 1A-B, the panels 3a-d would typically be inside of the vehicle 1 so they can be accessed by someone inside the vehicle 1 when the doors 2a-d are closed. Windows 5a, 5b, 5c, and 5d are attached to the doors 2a, 2b, 2c, and 2d, respectively.

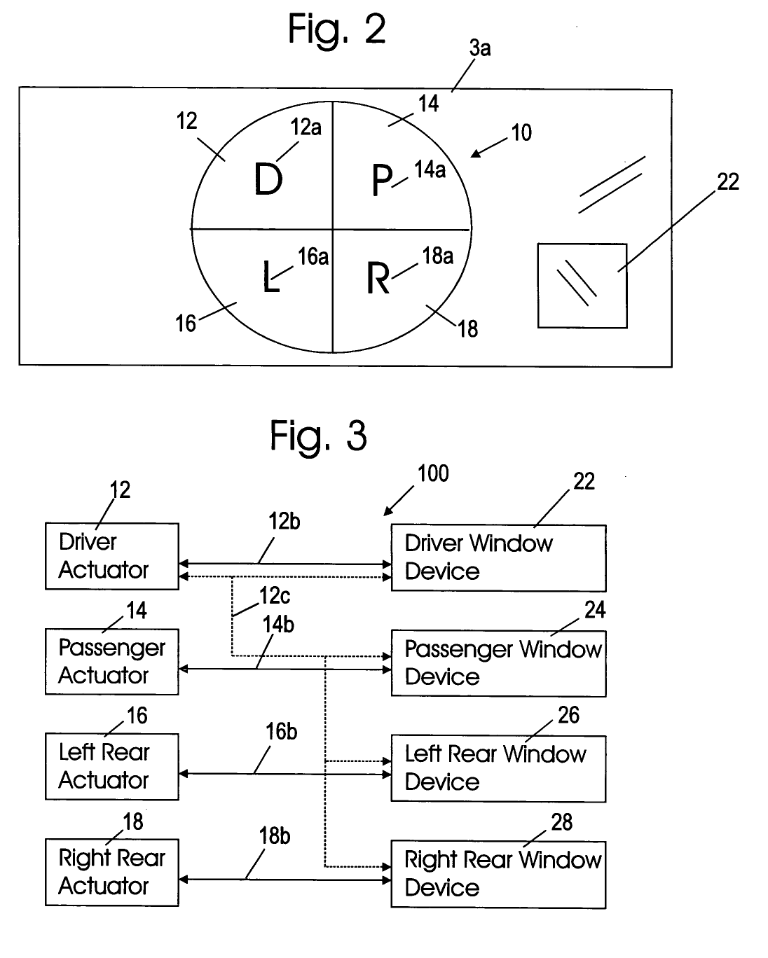

FIG. 2 shows a top view of a driver's door panel 3a which is fixed, inside the vehicle 1, to the driver's door 2a of the vehicle 1 shown in FIG. 1A. The driver's door panel 3a has fixed thereto a plurality of actuators 10. The driver's door panel 3a also has fixed thereto a driver window device 22. The plurality of actuators 10, although arranged together, are comprised of separate actuators including a driver actuator 12, a passenger actuator 14, a left rear actuator 16, and a right rear actuator 18. The driver actuator 12 has a designation of 12a or “D” imprinted thereon. The passenger actuator 14 has a designation of 14a or “P” imprinted thereon. The left rear actuator 16 has a designation of 16a or “L” imprinted thereon. The right rear actuator 18 has a designation of 18a or “R” imprinted thereon.

FIG. 3 shows a block diagram 100. The block diagram 100 shows the driver actuator 12 electrically connected by a communications line 12b to a driver window device 22, the passenger actuator 14 electrically connected by a communications line 14b to a passenger or front passenger window device 24, the left rear actuator 16 electrically connected by communications line 16b to a left rear window device 26, the right rear actuator 18 electrically connected by a communications line 18b to a right rear window device 28. The communications lines 12b, 14b, 16b, and 18b may be comprised of conductors, wireless communications lines, optic fibers, or any other type of communications lines. The actuators 12, 14, 16, and 18 may each include a toggle type push button switch. The window devices 22, 24, 26, and 28 may be located and fixed to the panels 3a, 3d, 3b, and 3c, respectively, of the doors 2a, 2d, 2b, and 2c, respectively. Each of the window devices 22, 24, 26, and 28 may include a switch or actuator and a power mechanism or device for opening and closing windows 5a, 5d, 5b, and 5c, respectively. Each of the window devices 22, 24, 26, and 28 may be a power window device.

In operation, a driver of the vehicle 1 can press any one of the actuators 12, 14, 16, and 18 to disable or enable the corresponding power window device of window devices 22, 24, 26, and 28. For example, assuming the left rear window device 26 for the left rear window 5b shown in FIG. 1A, is currently operational or enabled, a driver can disable the left rear window device 26 by pressing the left rear actuator 16 on the panel 3a. This sends a signal from the left rear actuator 16 to the left rear window device 26 via the communications line 16b and causes the left rear window device 26 to be disabled so that the left rear window 5b cannot be opened by use of the device 26 on the left rear door 2b. The left rear window device 26 can be thereafter enabled, by pressing the left rear actuator 16 again, which causes the device 26 to be enabled so that the left rear window 5b can be opened by the device 26.

Similarly, the driver actuator 12, the passenger acuator 14, and the right rear actuator 18 can be used to separately enable or disable the window devices 22, 24, and 28, respectively, via communications lines 12b, 14b, and 18b, respectively. When the devices 22, 24, 26, and 28 are enabled, they can be used to open or close the windows 5a, 5d, 5b, and 5c, respectively. When the devices 22, 24, 26, and 28 are disabled, they cannot be used to open or close the windows 5a, 5d, 5b, and 5c, respectively.

In one embodiment of the present invention, the driver actuator 12 may be adapted to disable all of the power window devices 22, 24, 26, and 28 instead of only power window device 22. In such an embodiment, the driver actuator 12 would be electrically connected to the power window devices 22, 24, 26, and 28 by communication lines 12c shown in dashed lines in FIG. 2.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. A vehicle comprising:
a first actuator; and
a first power window device which can be enabled or disabled by the first actuator; and
wherein when the first power window device is enabled, the first power window device can be used by an operator to open and close a first window in the vehicle;
and wherein when the first power window device is disabled, the first power window device cannot be used by an operator to open and close the first window in the vehicle;
and further comprising
a second actuator; and
a second power window device which can be enabled or disabled by the second actuator;
wherein when the second power window device is enabled, the second power window device can be used by an operator to open and close a second window in the vehicle;
and wherein when the second power window device is disabled, the second power window device cannot be used by an operator to open and close the second window in the vehicle.

2. The vehicle of claim 1 further comprising
a driver's door; and
wherein the first actuator and the second actuator are fixed to the driver's door.

3. The vehicle of claim 2 wherein
the first and the second actuator are adjacent to one another on the driver's door.

4. The vehicle of claim 1 further comprising
a drivers door and a front passenger door; and
and wherein the first power window device is fixed to the front passenger door.

5. The vehicle of claim 1 further comprising
a third actuator;
a third power window device which can be enabled or disabled by the third actuator; and
wherein when the third power window device is enabled, the third power window device can be used by an operator to open and close a third window in the vehicle;
and wherein when the third power window device is disabled, the third power window device cannot be used by an operator to open and close the third window in the vehicle;
and further comprising
a fourth actuator;
a fourth power window device which can be enabled or disabled by the fourth actuator;
wherein when the fourth power window device is enabled, the fourth power window device can be used by an operator to open and close a fourth window in the vehicle;
and wherein when the fourth power window device is disabled, the fourth power window device cannot be used by an operator to open and close the fourth window in the vehicle.

6. The vehicle of claim 5 further comprising
a driver's door;
a front passenger door;
a left rear door; and
and a right rear door; and
wherein the first power window device is fixed to the driver's door, the second power window device is fixed to the front passenger door, the third power window device is fixed to the left rear door, and the fourth power window device is fixed to the right rear door.

7. The vehicle of claim 5 further comprising
a driver's door; and
wherein the first, second, third, and fourth actuators are fixed to the driver's door.

8. The vehicle of claim 7 wherein
the first, second, third, and fourth actuators are grouped together on the driver's door.

9. A method comprising the steps of:
placing a first actuator in a vehicle;
placing a first power window device, which can be disabled or enabled by the first actuator, in a vehicle;
wherein when the first power window device is enabled, the first power window device can be used by an operator to open and close a first window in the vehicle;
and wherein when the first power window device is disabled, the first power window device cannot be used by an operator open and close the second window in the vehicle;
and further comprising
placing a second actuator in a vehicle; and
placing a second power window device, which can be enabled or disabled by the second actuator, in a vehicle,
wherein when the second power window device is enabled, the second power window device can be used by an operator to open and close a second window in the vehicle;
and wherein when the second power window device is disabled, the second power window device cannot be used by an operator to open and close the second window in the vehicle.

10. The method of claim 9 wherein
the first actuator and the second actuator are placed and fixed to a driver's door of the vehicle.

11. The method of claim 10 wherein
the first and the second actuator are placed and fixed adjacent to one another on the driver's door.

12. The method of claim 9 wherein
the first power window device is placed and fixed to a front passenger door of the vehicle.

13. The method of claim 9 further comprising
placing a third actuator in the vehicle;
placing a third power window device, which can be disabled or enabled by the third actuator, in the vehicle;
wherein when the third power window device is enabled, the third power window device can be used by an operator to open and close a third window in the vehicle;
and wherein when the third power window device is disabled, the third power window device cannot be used by an operator to open and close the third window in the vehicle;
and further comprising
placing a fourth actuator in a vehicle; and
placing a fourth power window device, which can be enabled or disabled by the fourth actuator, in a vehicle,
wherein when the fourth power window device is enabled, the fourth power window device can be used by an operator to open and close a fourth window in the vehicle;
and wherein when the fourth power window device is disabled, the fourth power window device cannot be used by an operator to open and close the fourth window in the vehicle.

14. The method of claim 13 wherein
the first power window device is placed and fixed to a driver's door of the vehicle;
the second power window device is placed and fixed to a front passenger door of the vehicle;
the third power window device is placed and fixed to the left rear door of the vehicle; and
the fourth power window device is placed and fixed to the right rear door of the vehicle.

15. The method of claim 13 wherein
the first, second, third, and fourth actuators are placed and fixed to a driver's door of the vehicle.

16. The method of claim 13 further comprising
grouping the first, second, third, and fourth actuators together on the driver's door.
